(19) United States
(12) Patent Application Publication
(10) Pub. No.: US 2003/0167225 A1
(43) Pub. Date: Sep. 4, 2003

(54) Favored client advance with audit protection method

(76) Inventor: Robert Lee Adams, St. Anthony, ID (US)

Correspondence Address: DYKAS, SHAVER & NIPPER, LLP, P O BOX 877, BOISE, ID, 83701-0877, US

(21) Appl. No.: 10/090,184

(22) Filed: Mar. 1, 2002

(51) Int. Cl. G06F 17/60

(52) U.S. Cl. 705/38

(57) ABSTRACT

A method for providing advances to a taxpayer based upon an anticipated income tax refund amount prior to the preparation and filing of the income tax return. The method comprising the steps of qualifying a taxpayer for an advance, preparing an application for the advance, transmitting the application to a central processing center; verifying that the client has no loans or offsets against the refund; verifying that a desired minimum amount of money is anticipated from the income tax return; issuing the advance; preparing the income tax return and collecting the amount of the advance along with additional fees from the received income tax return. An additional feature of providing prepaid tax preparer services is also included in the method.

### BACKGROUND OF THE INVENTION

1. Field of the Invention

The present invention generally relates to a method for providing enhanced taxpayer return preparation services, and more particularly a method of providing pre-approved advances in connection with tax preparation services including a provisional service contract with a taxpayer in the event of an Internal Revenue Service (IRS) audit.

2. Background Information

One of the requirements of United States law is that nearly every person files an income tax return at a designated time each year. These returns are filed with the Internal Revenue Service (IRS), which then verifies the information and ensures that an appropriate amount of income tax has been collected.

If more tax has been collected from an individual than they owe, a tax refund is prepared. If the IRS determines that an insufficient amount of tax has been collected from this person, then a process is undertaken to collect this deficiency.

The amount of tax that a person owes is determined by a variety of factors. Various programs and exceptions are made which allow parties to lower the amount of taxes that they pay. There are also policies that give tax credit to persons of lower incomes, allowing them to receive additional funds at the end of the year based upon a predetermined set of criteria. Tax provisions are lengthy and complex and many persons rely upon the assistance of an income tax preparation professional to assist them with preparing these tax returns. Tax preparation professionals, tax preparers, assist these individuals in preparing and filing their income tax returns.

In providing assistance to these individuals, several necessities become apparent. First, many individuals need the money that they would be receiving from their income tax return at a time prior to the receipt of these funds or the filing of their tax return. Second, many of these same individuals may need subsequent tax preparation assistance from a tax preparer in the event of a review or audit by the IRS. When this time arises, these persons may not have the financial means for hiring a tax professional to assist them.

Accordingly, it is an object of the present invention to provide favored client advances to taxpayers, prior to the preparation of their income tax return and collecting the amount of that loan from the income tax return at some subsequent time. Furthermore, it is an object of this invention to provide prepaid audit protection services by a tax preparer in the event of an IRS inquiry or audit.

Additional objects, advantages and novel features of the invention will be set forth in part in the description as follows, and in part will become apparent to those skilled in the art upon examination of the following, or may be learned by practice of the invention. The objects and advantages of the invention may be realized and obtained by means of the instrumentalities and combinations particularly pointed out in the appended claims.

### SUMMARY OF THE INVENTION

These objects are achieved by the following method in which a taxpayer is able to receive a pre-return preparation loan to be repaid to the loaning party from the proceeds of a subsequent income tax refund. In addition to the pretax return preparation loan, a method is provided for securing prepaid tax preparer services. In a first portion of this method, an application for a loan is completed utilizing a computer-processing program. The loan application is transmitted to a host central processing center, which verifies that the client expects a desired minimum amount of money to be received from the income tax refund and that no other loans or offsets exist which would reduce the amount of the advance. If the central processing center verifies the loan, the loan is extended to the client who then accepts the terms of the loans.

Later, the client's income tax return is prepared. If the income tax return, verification form or schedule is likely to be targeted for review by the IRS, this is determined and a contract with the client is made to provide designated levels of services in the event of an IRS inquiry or audit. The payment for these services may be recovered along with the amount of the loan. The federal income tax return with the accompanying documentation is then filed. The return from the IRS is sent to a bank which has a deposit account prepared to receive the deposit from the IRS. The deposit is received and the amount of the loan and associated fees and expenses are recovered from the amount of the tax return. Any excess is forwarded to the taxpayer.

This method enables qualified taxpayers to both obtain advances to cover expenses prior to the filing of the income tax return, and to obtain prepaid tax preparer services in the event of an IRS inquiry or audit. This method also increases the likelihood that the lender will recover these loans.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWING

FIG. 1 is a flowchart describing the preferred embodiment of the method of this invention

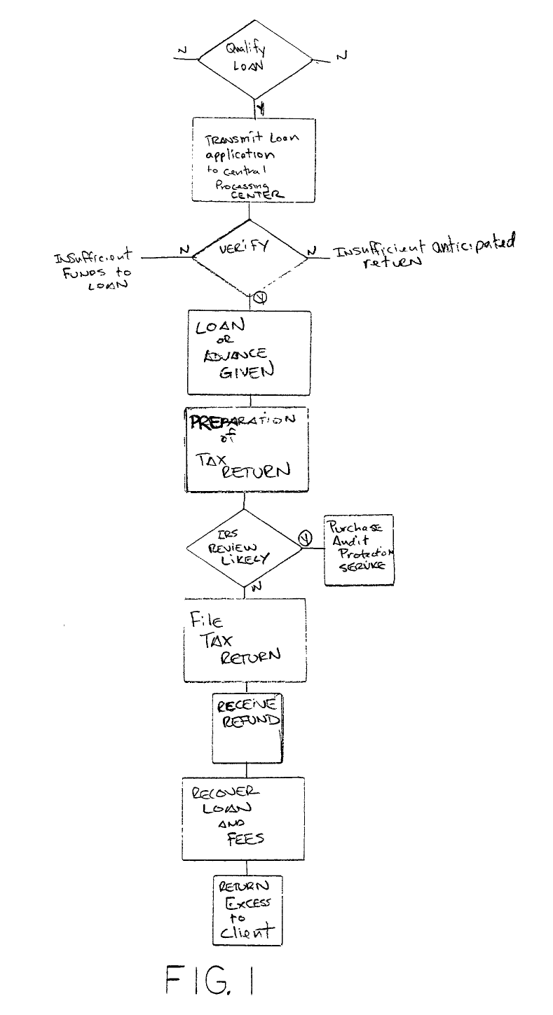

### DESCRIPTION OF THE PREFERRED EMBODIMENTS

While the invention is susceptible to various modifications and alternative constructions, certain illustrated embodiments thereof have been shown in the drawings and will be described below in detail. It should be understood, however, that there are no intentions to limit the invention to the specific form disclosed, but, on the contrary, the invention is to cover all modifications, alternative constructions, and equivalents falling within the spirit and scope of the invention as defined in the claims. While there is shown and described the present preferred embodiment of the invention, it is to be distinctly understood that this invention is not limited thereto but may be variously embodied to practice within the scope of the following claims.

The invention is a method, which provides taxpayers access to an amount of money, usually $500.00, based upon an anticipated amount of income tax return, prior to the preparation and filing of that income tax return with the IRS. The method also allows taxpayers to purchase pre-paid tax preparer assistance in the anticipation of a likely IRS review or audit. The collection of the amount of the loan and/or the fees for audit protection services is obtained through the taxpayer's subsequent income tax return.

This method provides several advantages to its participants. First, it assists clients by providing them with a nearly instant amount of money for immediate emergencies or necessities. Clients are still able to obtain another refund anticipated loan or refund anticipated check for the balance of the income tax refund with the completion of the return. Financial institutions as well as tax preparers receive fees for issuing such advances. Additionally, the repayment of the loan is guaranteed by collection of the instant loan through the banking institution where the income tax refund is to be received.

An additional feature of the method is the taxpayer's ability to purchase prepaid tax preparer assistance in the event of an IRS inquiry or audit. This additional feature allows taxpayers to prepay for future services that they may later need. It also enables these individuals to have access to tax preparer professionals at a time when they might otherwise not be able to obtain such assistance. This method also provides an additional source of revenue to the tax preparer. These receipts can be used to fund advances if so desired.

The method is employed in a situation where a tax preparer meets with a client seeking an advance of an amount of money. The first step that a tax preparer will undertake is to qualify the client for a loan. This qualification can be based upon a variety of factors. These factors include: the receipt of successful refund anticipated loans, or refund anticipated checks from the two years prior; two years prior history of electronic filings with proof of receiving funds in an amount of $1,500.00 or more; no other offsets from the IRS or credit agency as verified by telephone, good general credit; and no change in marital status (except from single or head of household to married filing jointly). If the client meets these qualifications, including an absence of an offset against the federal income tax return, an application is completed for the advance. This entire process may be undertaken by a computer-processing program or by some other means.

The completed application includes information regarding the parties' social security number, income, address, income tax information, number of dependents, credit to debt ratio, and a variety of other typical loan based factors. Once the application is completed it is transmitted to a central processing center. Usually this transfer is electronic utilizing a conventional means for electronic transmission such as the Internet, however other means may also be used.

At the central processing center, the information is checked and verified, usually by a host computer. In addition to the information on the application, the central processing center verifies that a desired amount of money is anticipated from the future income tax refund to process the loan. A typical situation requires that the anticipated refund must be $1,500.00 or more for a $500.00 loan. The exact percentages and credit worthiness, which is required to process a loan, will be determined by independent lenders based upon factors that are relevant to them.

The central processing center also verifies that sufficient funds exist in a loan dispersal account to grant the loan. In one embodiment of the invention, this step is unnecessary as the loan dispersal account is based upon an agreement with a banking institution which simply issues the loan and then creates a debt based deposit account into which the income tax return will be received. In another embodiment of the invention, this account is a separate account owned by the tax preparer into which he deposits monies from a variety of sources.

Once the application has been deemed to be qualified and verified, a signature or some other form of acceptance of the advance and the terms under which it is given is obtained from the client. This acceptance will most commonly be in the form of a signature, but other forms of acceptance including verified electronic signatures and verifications may also be employed.

An amount of money is then advanced to the client. This advance may be given in any of a variety of ways including by cash, check, or other means for funds transfer. The advance is given from an account that is linked to a financial institution that also has been set up to receive the deposit of the anticipated income tax refund.

The tax preparer will then prepare an income tax return for the client. The time period between the granting of the loan and the preparation of the income tax return may be a matter of days, weeks or even months as long as the other steps for qualification and verification have occurred.

In preparing an income tax return, a determination may be made as to whether or not this income tax return is potentially targeted for review by the IRS. This determination may be made by the tax preparers themselves or alternatively may be made by a computer review software program based upon a series of pre-selected criteria. Some of the criteria which may trigger the finding that the return is potentially targeted for review by the IRS include the claim for earned income child credit (EIC), the filing of a 2106 form, filing schedules C, E or F, or other designated factors.

If any of these criteria apply, the tax preparer may be prompted to invite the taxpayer to obtain an audit protection policy which will provide the taxpayer access to the tax preparer's services for assistance with dealing with IRS problems resulting from filing that return. In exchange for the future services in the event of an IRS review or audit, the tax preparer receives payment up front and will charge no fees to perform the services outlined in the contractual agreement.

The funds collected by the tax preparer can then be held for a designated period of time and used to build a cash reserve for the loan advance program. This protection is backed by the central processing center which will honor those commitments made by the tax preparers and will assist the taxpayers in resolving their issues with the IRS, according to the outlines of the contract.

The income tax return is prepared by the tax preparer and filed for the client. This filing includes the actual submission of the designated forms and accompanying documentation as required by the regulations of the IRS. The income tax return designates that the refund be deposited into an existing deposit account at a financial institution. After the IRS verifies the income tax return and authorizes a refund, the refund is then transmitted or directed to the deposit account. The amount of the advance along with any fees including the fees for the preparation of the income tax return, advance fees, the cost of the audit protection program and other fees and expenses are collected from the income tax refund. The remainder of the amount of the refund is forwarded to the client.

This method enables the taxpayer to receive the tax preparation services and advances based upon their expected income tax refund without having to wait until the income tax return is actually filed or prepared. This also enables a taxpayer of limited means to prepay for future tax preparer assistance when they have the funds to do so. Thus providing these individuals access to professional taxpayer assistance, which they may otherwise have not obtained.

The method also provides the tax preparer and other parties the ability to give advances based upon anticipated income tax return amounts prior to the filing and, in some cases, prior to the preparation of the income tax return. The recovery of these loans is significantly enhanced by the receipt of these loans by a financial institution prior to the access and receipt of these refunds by the taxpayer.

From the foregoing description, it will be apparent that various changes may be made without departing from the spirit and scope of the invention as defined by the following claims.

I claim:

1. A method for granting advances and loans based upon an anticipated income tax refund prior to the preparation of the income tax return comprising the steps of:
qualifying a client for a loan;
completing an application for said loan;
transmitting said application to a central processing center;
verifying that said client has no loans set against said anticipated income tax refund;
verifying that adequate funds are anticipated from said anticipated income tax return to process said loan;
obtaining acceptance of said loan from the client;
transferring an amount of money equal to said loan to said client;
preparing an income tax return including compiling and preparing proper documentation;
filing said income tax return with proper documentation when completed;
receiving said income tax refund into a receiving account;
recovering said amount of money together with at least one fee from said receiving account; and
returning any remaining amounts of money belonging to said client to said client.

2. The method of claim 1 wherein the application for the loan is completed using a computer processing program.

3. The method of claim 2 wherein the step of transmitting the application is done electronically.

4. The method of claim 3 wherein the step of transmitting the application is done via a globally accessible computer network.

5. The method of claim 1 wherein the step of obtaining acceptance of the loan includes printing an acceptance form and obtaining a signature from said client on said form.

6. The method of claim 1 wherein said loan is dispersed from a loan dispersing account maintained by a banking institution, said banking institution also the location where the receiving account is located.

7. The method of claim 1 wherein said loan is dispersed from a loan dispersing account maintained by a financial services company other than a banking institution.

8. The method of claim 7 wherein the financial services company is a tax preparation organization.

9. The method of claim 8 wherein the account is funded by receipts from a contractual agreement, whereby a tax preparer contracts to provide a set of designated services in the event of a review by the Internal Revenue Service.

10. A method for providing pre-purchased tax preparer services in conjunction with a system for granting loans, comprising the steps of;
identifying tax returns as being potentially targeted for review by the Internal Revenue Service;
contracting with a taxpayer to provide a level of services in the event of a review by the Internal Revenue Service in exchange for a fee paid in advance;
receiving the fee from the taxpayer; and
performing the services contracted for when obligated by said contract.

11. The method of claim 10 further comprising the step of depositing a portion of the fee into a loan dispersal account.

12. The method of claim 11 wherein said method is included as a step within a method for qualifying, granting and collecting a loan based upon an anticipated income tax refund comprising the steps of;
qualifying a client for a loan;
completing an application for said loan;
transmitting said application to a central processing center;
verifying that the client has no other loans set against said anticipated refund;
verifying that adequate finds are anticipated from said income tax return to process the loan;
obtaining verification of acceptance of the loan by the client;
issuing a check drawn on a bank which has a deposit account prepared for receipt of the income tax refund;
preparing a federal income tax return for the client including, compiling and completing all necessary support information;
filing the prepared federal income tax return with accompanying support documentation;
receiving an income tax refund into a receiving account;
recovering an amount of money equal to said loan together with a designated processing fee, from said receiving account; and
transferring an amount of money equal to the amount of the income tax refund less the said amount of money equal to said loan to said client.

13. The method of claim 13 wherein the step of issuing said check is performed at least two weeks prior to the step of preparing the federal income tax return.

14. A method for operating a self-funding, instant loan, qualification, issuance and collection program based upon an anticipated income tax refund comprising the steps of:
qualifying a client for a loan based upon a variety of factors, including the absence of an offset against a federal income tax return;
completing an application for said loan using a computer processing program;
transmitting said application to a central processing center;
verifying that the client has no other loans to reduce the amount of said anticipated refund;
verifying that a desired minimum amount of money is anticipated from said anticipated income tax return;
verifying that sufficient funds exist in a loan dispersing account to grant the loan;
obtaining a signature from said client accepting the loan and its terms;
issuing a check drawn on a loan dispersing account;
preparing an income tax return for said client;
determining if said income tax return is likely to be targeted for review by a government agency known as the Internal Revenue Service;
contracting with said client to provide a level of services in the event of a review by the Internal Revenue Service in exchange for a fee paid in advance;
receiving said fee from the client;
depositing a portion of the fee into the loan dispersal account;
filing said income tax return;
receiving an income tax refund into a receiving account;
recovering an amount of money equal to said loan together with a designated processing fee from said receiving account; and
dispersing to said client an amount of money equal to said income tax refund less said amount recovered;
whereby the funds collected from clients in contracting for future services comprise a body of funds from which loans can be made and the collection of said loans is provided by direct deposit from the Internal Revenue Service into a deposit account.
